(19) United States
(12) Patent Application Publication
(10) Pub. No.: US 2020/0014226 A1
(43) Pub. Date: Jan. 9, 2020

(54) BATTERY BANKS WITH INTEGRATED CHARGING CABLES

(71) Applicant: Incipio, LLC, Irvine, CA (US)

(72) Inventors: Timothy Hemesath, Clovis, CA (US); Josue Gonzalez, Corona, CA (US)

(73) Assignee: Incipio, LLC, Irvine, CA (US)

(21) Appl. No.: 16/572,593

(22) Filed: Sep. 16, 2019

Related U.S. Application Data
(63) Continuation-in-part of application No. 15/348,866, filed on Nov. 10, 2016.
(60) Provisional application No. 62/272,445, filed on Dec. 29, 2015.

(51) Int. Cl. H02J 7/00; H02J 7/02

(52) U.S. Cl. CPC H02J 7/0045; H02J 7/025; H02J 7/0013

(57) ABSTRACT

A portable charging system having a battery bank that may be used with a charging dock is disclosed. The battery bank has an integrated charging cable that is configured to wrap around two sides of the battery bank to form a storage mode and to unwrap to form a free-floating cable mode.

### CROSS-REFERENCE TO RELATED APPLICATIONS

This application is a continuation-in-part of U.S. patent application Ser. No. 15/348,866, filed on Nov. 10, 2016, which claims the benefit of and priority to U.S. Provisional Patent Application Ser. No. 62/272,445, filed on Dec. 29, 2015, the entireties of which are hereby incorporated herein by reference.

### BACKGROUND

### Field of the Invention

The present disclosure relates to a portable charging system with swappable battery banks for charging portable or mobile consumer electronic devices such as cellular or smart phones, computing tablets, MP3 players, gaming devices, laptop computers, portable charging devices therefor, and the like, and more particularly a portable charging system that may include a charging dock and portable rechargeable battery banks.

### Description of the Related Art

Docking station and portable rechargeable battery banks are known in the art. It is desirable that the charging dock is as thin as possible to make it portable or easy to carry around. However, when the charging dock is thin, a charging cavity built on the dock may not have enough supporting depth to secure the battery banks that are under charging. Therefore, the battery bank is unstable while charging and the charging process may be interrupted. Thus there is a continuing need to improve the configuration of a conventional docking station and battery banks to enhance user experience.

### SUMMARY

A portable charging system having a battery bank that may be used with a charging dock is disclosed herein. The battery bank has an integrated charging cable that is configured to wrap around two sides of the battery bank to form a storage mode and to unwrap to form a free-floating cable mode.

### BRIEF DESCRIPTION OF THE DRAWINGS

FIG. 1 illustrates a representative portable charging system with one battery bank plugged into the charging dock and the other connected to a mobile device.

FIG. 2 is a perspective view of a battery bank.

FIG. 3 is a perspective view of a charging dock with a battery bank inserted.

FIG. 4 is another perspective view of the charging dock and battery bank of FIG. 3.

FIGS. 5A-5F are front, rear, left, right, top, and bottom views of the charging dock and battery bank of FIGS. 3 and 4.

FIG. 6 is a perspective view of the battery bank of FIG. 2 with the charging cable wrapped in a closed position.

FIGS. 7A-7F are front, rear, left, right, top, and bottom views of the battery bank of FIG. 6.

### DETAILED DESCRIPTION OF THE ILLUSTRATED EMBODIMENTS

Features, aspects, and advantages are described below with reference to the drawings, which are intended to illustrate but not to limit the invention. In the drawings, like reference characters denote corresponding features consistently throughout similar embodiments.

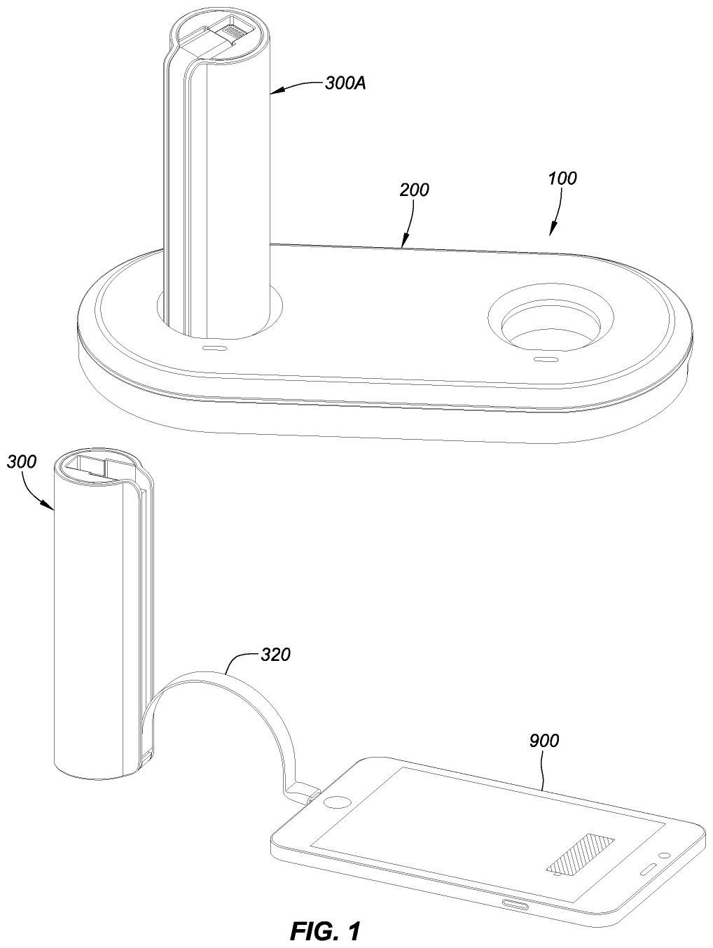

FIG. 1 illustrates a representative portable charging system 100 with one battery bank 300A docked into a charging cavity of charging dock 200 while another battery bank 300 is connected with a mobile device 900 through a cable 320 to supply power to the mobile device 900. Each of the battery banks 300 and 300A may be independently docked into any one of the charging cavities of the charging dock 200 to receive power. When both battery banks 300 and 300A are docked into the charging dock 200, both battery banks 300 and 300A may be charged simultaneously. It is understood that the charging system 100 may include more than two battery banks. It is also understood that the charging system 100 may include only one battery bank.

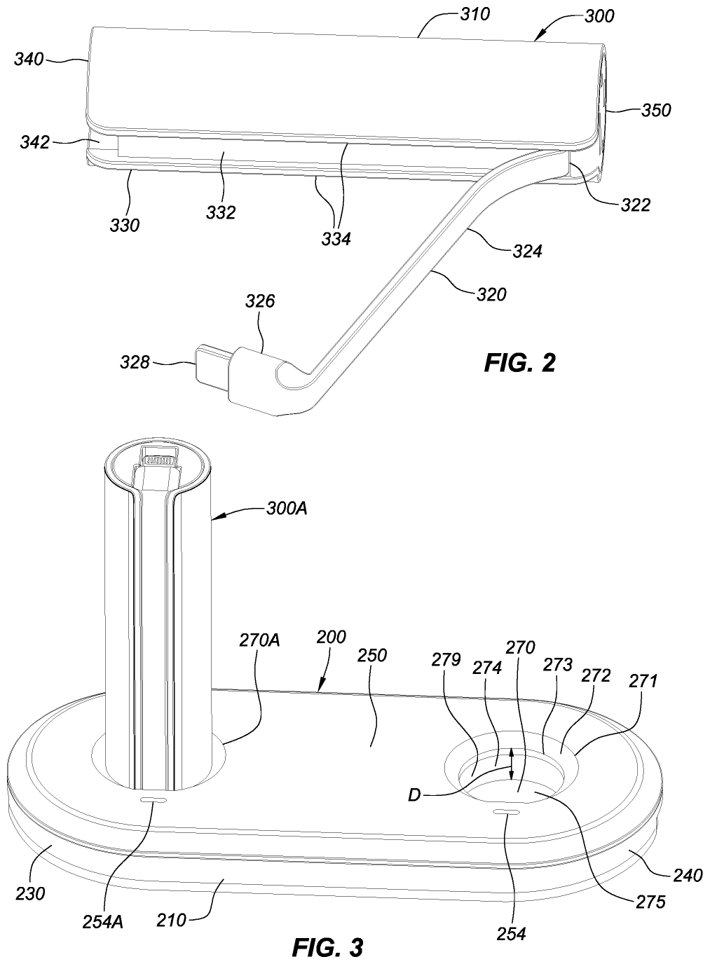

FIG. 2 is a perspective view of a battery bank 300. The battery bank 300 has a generally cylindrical housing 310 that includes therein one or more rechargeable batteries (not shown). In some embodiments, the rechargeable batteries may utilize standard-sized cylindrical lithium-ion (Li-Ion) batteries, such as 14650, 18650, and 26650 batteries. In other embodiments, the rechargeable batteries may utilize non-standard-sized batteries or other materials besides lithium-ion, such as nickel-metal-hydride (NiMH), nickel-metal cadmium (NiCd), lithium-sulfur, graphene supercapacitors, aluminum-graphite, sodium-ion, lithium-polymer, etc. The battery bank may be provided with a removable cap to allow rechargeable batteries to be removed or placed by the user, or the battery bank may be permanently sealed to preclude the removal or replacement of the rechargeable batteries.

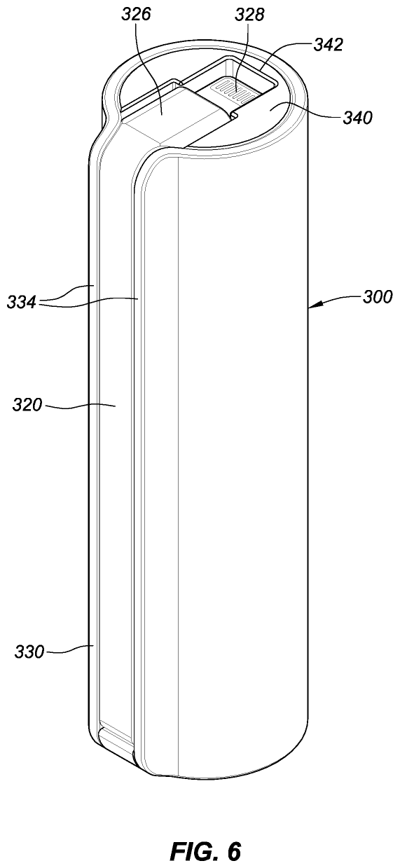

The battery bank 300 has a front facing side 330, a top side 340, and a bottom side 350. The battery bank 300 includes a built-in cable 320 that may be concealed within a groove formed into the side of the housing 310 in a storage mode when the cable 320 is fully wrapped in a first direction as shown in FIG. 6. The charging connector of the cable is tucked into a retention or storage cavity 342 that is formed on the top side 340 of the housing 310. When the cable 320 is partially unwrapped, as shown in FIG. 2, the flexible cable may be connected to an electronic device. When the cable 320 is fully wrapped, the retention or storage cavity 342 may prevent cable 320 from becoming unwrapped. For example, retention or storage cavity 342 may utilize a material that grips housing 326 of cable 320. In some embodiments, the angle of a housing 326 relative to a cable portion 324 of the built-in cable 320 may provide sufficient tension to prevent unwrapping when the housing 326 is placed in the retention or storage cavity 342. In addition, the built-in cable 320 may include a cap separately or as a part of the built-in cable 320 that provides protection to the housing 326 from elements such as dust or moisture when not in use. For example, a flexible cap may be attached to the built-in cable 320 or provided separately that forms a seal with the housing 310 to prevent moisture or dust from reaching the housing 326 when not in use. As another example, a flexible cap may be attached to the built-in cable 320 or provided separately that forms a seal with the retention or storage cavity 342 to prevent moisture or dust from reaching the housing 326 when not in use.

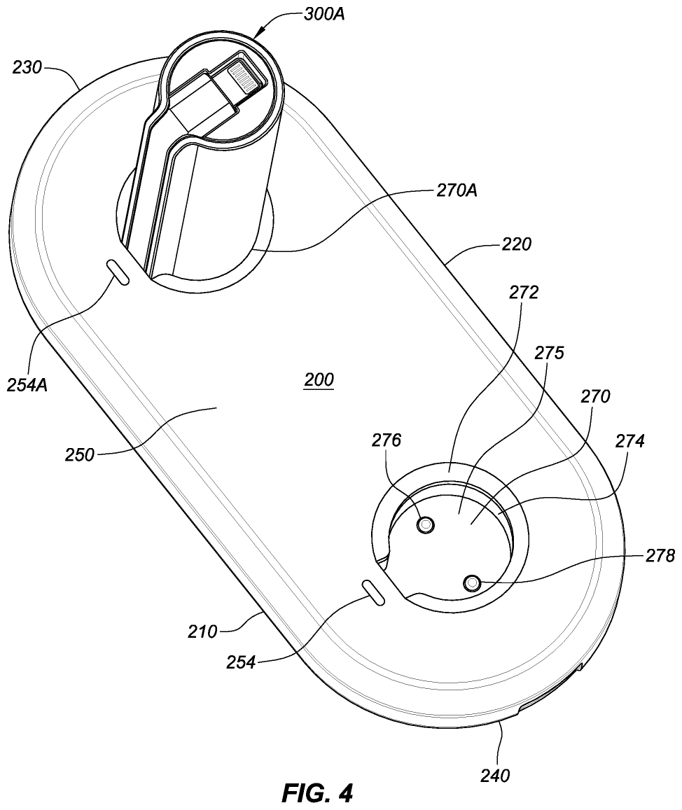

FIGS. 3-4 are perspective views of a charging dock 200 with a battery bank 300A inserted. The battery bank 300A may have the same functional configuration as that of the other battery bank 300. As illustrated, the battery bank 300A is secured into a charging cavity 270A while another charging cavity 270 has no battery bank being inserted. When the battery bank 300A is secured in the charging cavity 270A, the battery bank 300A itself is in a storage mode. A color-coded ring, band, or label may be applied to battery banks 300 and 300A to distinguish them from each other.

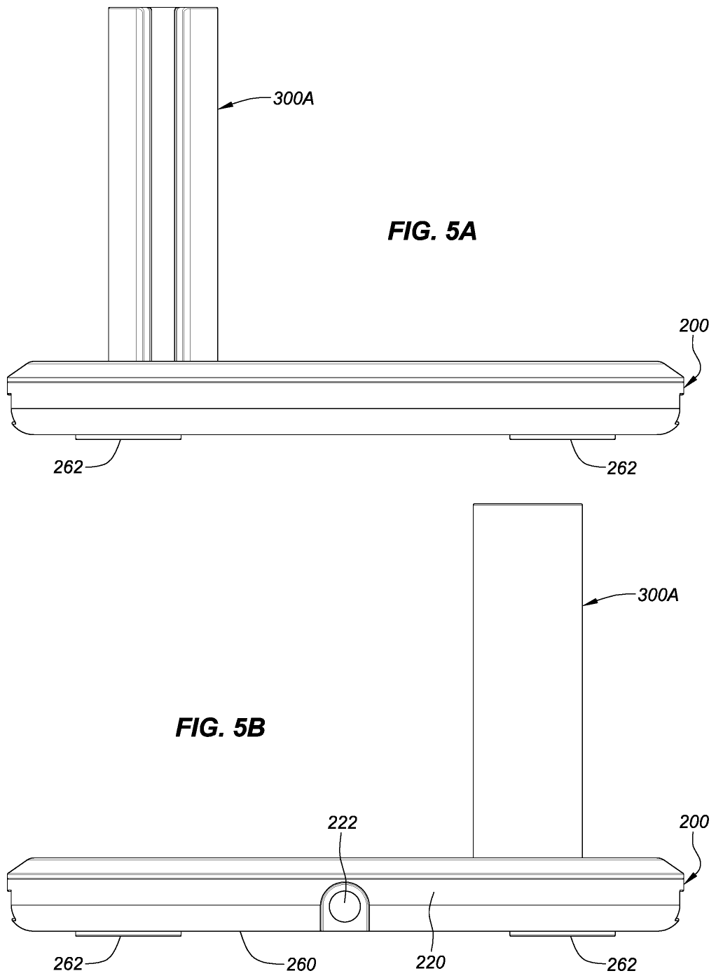

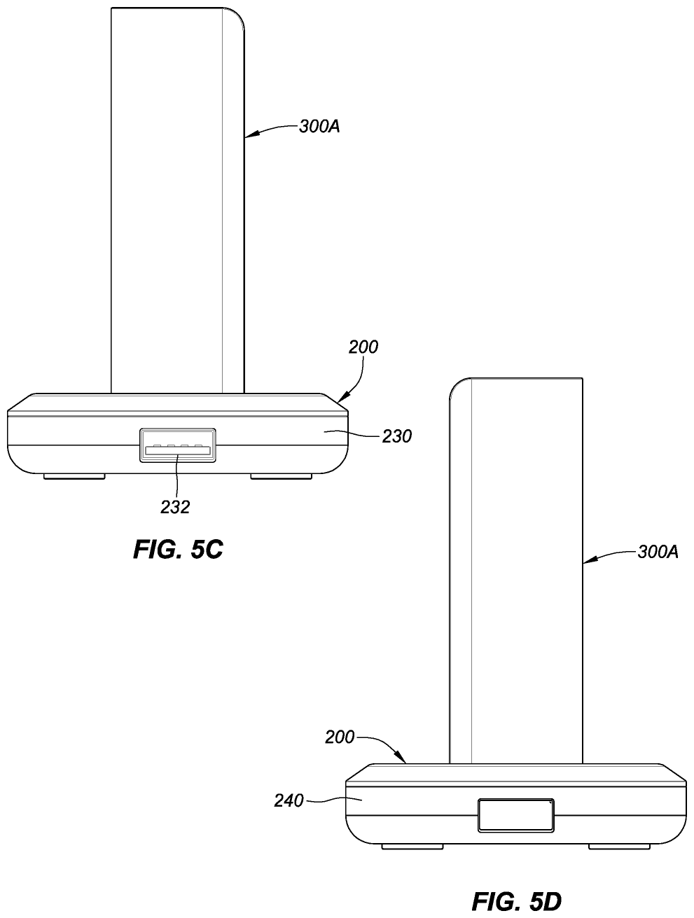

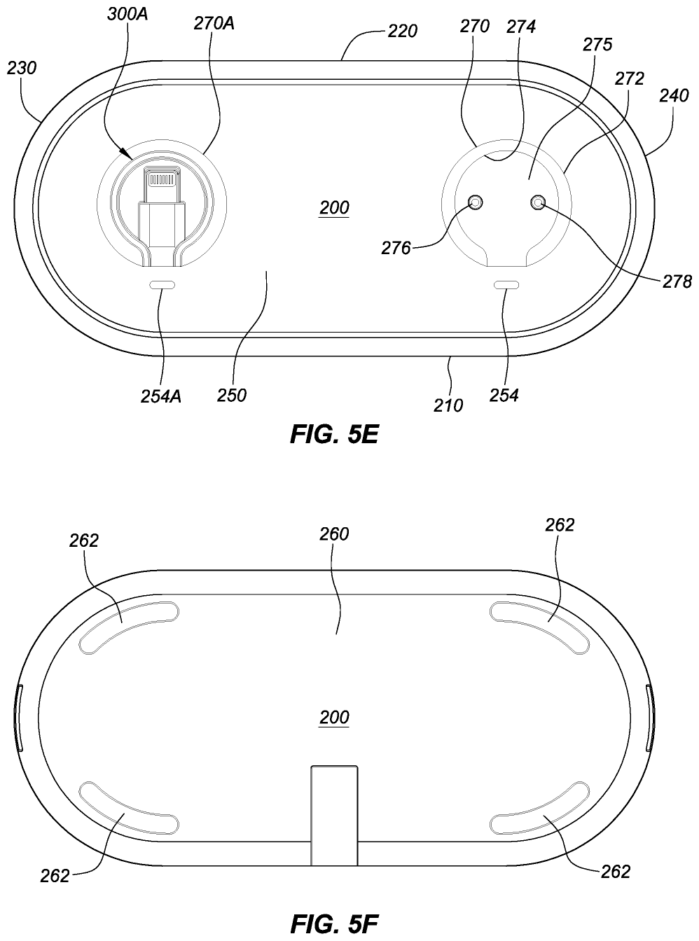

FIGS. 5A-5F are front, rear, left, right, top, and bottom views of the charging dock 200 and battery bank 300A of FIGS. 3 and 4. The charging dock 200 has a front side 210, rear side 220, left side 230, right side 240, top side 250, and bottom side 260. The left side 230 and right side 240 are curved. It is understood that the left side 230 and right side 240 may be straight or take other shapes. A height of the charging dock 200 is defined by the distance between the top side 250 and bottom side 260.

The top side 250 has charging cavities 270 and 270A that are configured to secure battery banks in charging position. As shown, the crater-shaped charging cavity 270 is configured to have an upper portion 272 and a lower portion 274. The upper portion 272 may have a wider upper rim 271 and a narrower lower rim 273 to provide easy access to or removal of the battery bank 300. The lower portion 274 is sized to receive the bottom portion of the battery bank 300. The diameter of the lower portion 274 may be the same as the diameter of the lower rim 273.

It is desirable that the charging dock 200 be thin in height to make it lightweight, portable, and easy to carry around. However, when the charging dock 200 is thin in height, charging cavities 270 and 270A may not have enough supporting space to hold the battery banks that are in charging position. The supporting space may be defined by the depth D between the lower rim 273 of the outer ring portion 272 and the bottom side 275 of the charging cavity 270.

As better shown in FIGS. 4 and 5E, the charging cavity 270 is configured to have two charging contact pins 276 and 278 that may be plugged into charging contacts 356 and 358 on the bottom side 350 of the battery bank 300 to supply power to the battery bank 300 when it is secured in the charging position. This configuration of two charging contact pins 276 and 278 may provide further stability to the battery bank 300 when it is secured in the shallow charging cavity 270.

Alternatively, the charging contact pins may be provided on the side wall 279 of the lower portion 274. In this configuration, the charging contacts may be provided on corresponding positions of the battery bank 300. In some embodiments, the charging contacts 356 and 358 may be omitted in favor of alternative charging methods. For example, battery bank 300 may utilize wireless charging. Alternatively, the charging contacts 356 and 358 may be replaced by a standardized connector such as a USB-C port. As better shown in FIG. 5F, battery bank 300 may also utilize both charging contacts 356 and 358 and a standardized connection port 354 (e.g., USB Type B, USB Type C, Lightning) for purposes of charging the battery bank 300. In addition, the battery bank 300 may also include a power button 352, which may be made of flexible material incorporated into the housing. In some embodiments, the power button 352 may be used to reset or power cycle the battery bank 300. In addition, the power button 352 may be used to turn on or off the battery bank 300. The battery bank 300 may also include a status indicator 360 to indicate the remaining charge of the battery bank 300 (e.g., green/yellow/red).

Indicators 254 and 254A may be provided to show the charging level or status on the charging cavities 270 and 270A. The indicators 254 and 254A may be LEDs in any color as desired.

As shown in FIG. 5B, the rear side 220 may have a power input 222 to connect the charging dock 200 to a power source that is configured to supply power to the charging dock 200.

As shown in FIG. 5C, the left side 230 of the charging dock 200 may be provided with a USB port 232 that is configured to provide power to other electronic devices.

As shown in FIG. 5F, the bottom side 260 of the charging dock 200 may be provided with a plurality of feet 262 that are configured to be capable of providing additional elevation to the charging dock 200 and may also be formed with materials that assist in dampening vibrations.

FIG. 2 shows the unwrapping of the charging cable 320 around the housing 310 and the corresponding position of the charging connector 328 and connector housing 326. When the cable 320 is unwrapped around the cable connection point 322, the charging connector 328 hangs more freely and the battery bank 300 is in a flexible or free-floating cable mode. In this flexible or free-floating cable mode, the cable 320 is extended out from the housing 310 of the battery bank 300 to allow charging a load (e.g., cell phone, tablet, computer, MP3 player, iPad, gaming device, etc.) as illustrated in FIG. 1. This cable 320 provides convenience to the user so that the user does not need to carry an extra charging cable.

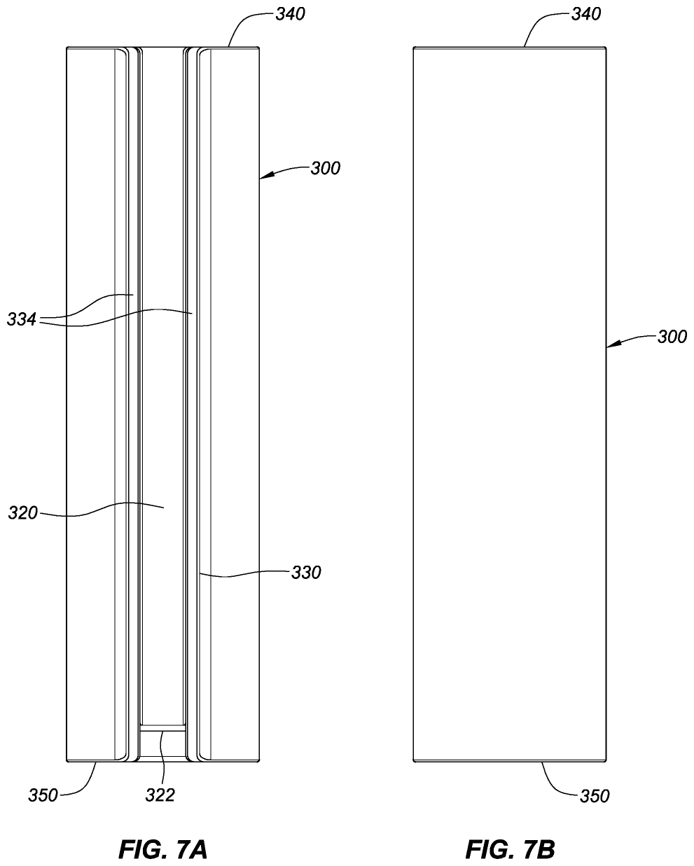

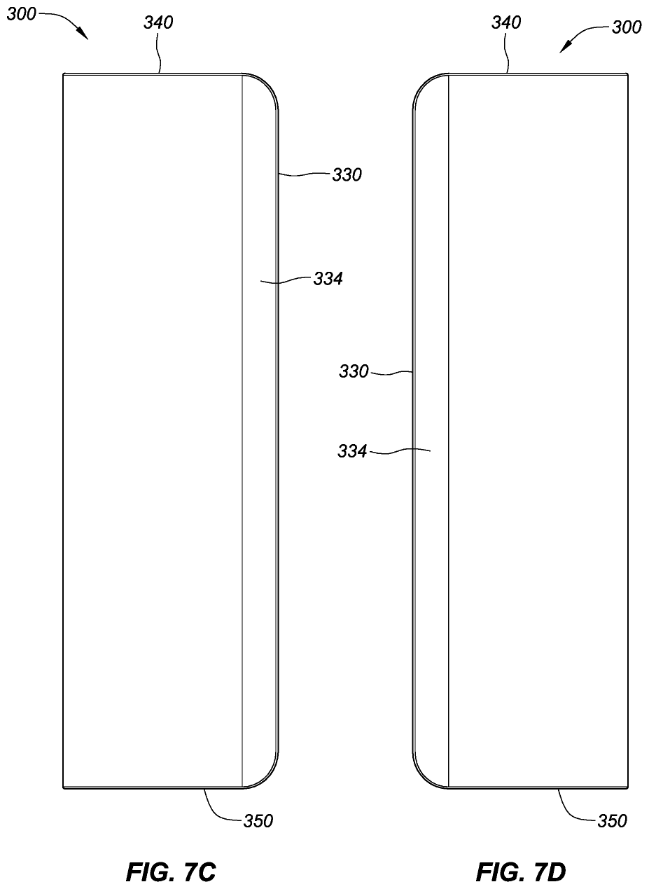

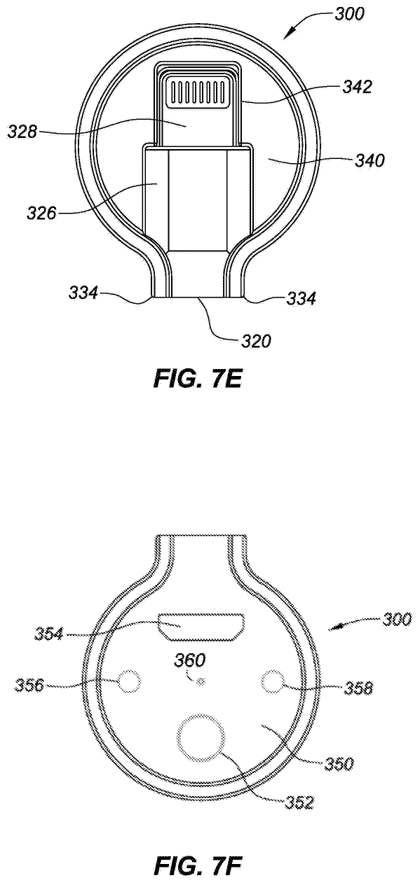

When the charging cable 320 is fully wrapped around the housing 310 as shown in FIG. 6, the battery bank 300 may be put into, or configured into, a storage mode. FIGS. 7A-7F are front, rear, left, right, top, and bottom views of the battery bank in the storage mode of FIG. 6. In the storage position, the housing 326 of the connector 328 may be tucked into a retention or storage cavity 342 that is formed on the top side 340 of the housing 310. The retention cavity 342 is dimensioned such that the charging connector 328 and connector housing 326 are exposed on either end to facilitate the user's insertion and removal of the charging connector 328 and connector housing 326 from the storage cavity 342. A notch may be included in the storage cavity 342 to allow the user more ready access to the connector housing 326 to ease removal and insertion into the storage cavity 342.

The housing 310 includes a groove 332, as shown in FIG. 2, that is formed around the front side 330 and into the top side 340 of the housing 310. The groove 332 is defined by a recessed region between wall structures 334 protruding on the front side 330. The groove 332 is dimensioned to receive the cable portion 324 when the charging cable 320 is wrapped around the perimeter of the front side of the housing 310 in the storage position. In some embodiments, the groove 332 may utilize a material to grip the cable portion 324, such as plastic or rubber, when the cable portion 324 is placed in the groove 332.

This storage mode conveniently provides a small, compact, and portable configuration of the battery bank 300 with a built-in cable 320 that is, among other things, user and travel-friendly.

Although various aspects and implementations are herein disclosed in the context of certain preferred embodiments, implementations, and examples, it will be understood by those skilled in the art that the present invention extends beyond the specifically disclosed embodiments to other alternative embodiments and/or uses of the inventive aspects and obvious modifications and equivalents thereof. In addition, while a number of variations of the aspects have been noted, other modifications, which are within their scope, will be readily apparent to those of skill in the art based upon this disclosure. It should be also understood that the scope this disclosure includes the various combinations or sub-combinations of the specific features and aspects of the embodiments disclosed herein, such that the various features, modes of implementation and operation, and aspects of the disclosed subject matter may be combined with or substituted for one another. Thus, it is intended that the scope of the present invention herein disclosed should not be limited by the particular disclosed embodiments or implementations described above, but should be determined only by the scope of the claims below.

Similarly, this method of disclosure, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims below are hereby expressly incorporated into this Detailed Description, with each claim standing on its own as a separate embodiment.

What is claimed is:

1. A portable charging system for a portable mobile device, the charging system comprising:
at least one battery bank having a top surface, an opposing bottom surface, and one or more sidewalls extending between said top and bottom surfaces, wherein the at least one battery bank has a charging cable originating at an integrated connection point next to, on, or in the opposing bottom surface, a groove along the one or more sidewalls from the connection point to the top surface for storing a cable portion of the charging cable, and a storage cavity in the top surface for storing a charging connector of the charging cable.

2. The portable charging system of claim 1, wherein the storage cavity is designed to grip the charging connector.

3. The portable charging system of claim 1, wherein the angle of the storage cavity relative to the groove is sufficient to hold the charging connector in the storage cavity and the cable portion in the groove by way of tension applied along the length of the charging cable when the charging connector is placed into the storage cavity.

4. The portable charging system of claim 2, wherein the groove is designed to grip the cable portion of the charging cable.

5. The portable charging system of claim 2, wherein the opposing bottom surface has at least one of a standardized charging connection port, a pair of charging pins or contacts, and a wireless interface for receiving power to charge the battery bank.

6. The portable charging system of claim 2, wherein the battery bank further includes a connector cap to cover the charging connector when it is inserted into the storage cavity.

7. The portable charging system of claim 2, wherein the housing of the battery bank contains at least one rechargeable battery.

8. The portable charging system of claim 2, wherein the battery bank has a removable cap to allow the at least one rechargeable battery to be removed or replaced by the user.

9. The portable charging system of claim 2, wherein the battery bank is permanently sealed to preclude the removal or replacement of the at least one rechargeable battery.

10. The portable charging system of claim 5, further comprising a charging dock having a top surface, an opposing bottom surface, at least two sidewalls extending between said top and bottom surfaces, a charging cavity opened from the top surface having a bottom side, and at least two charging pins provided at the bottom side of the charging cavity.

11. The portable charging system of claim 10, wherein the charging pins of the charging dock can plug into the charging contacts of the battery bank when the battery bank is secured in the charging cavity to supply power to the battery bank while also providing further stability to the battery bank that is in charging position.

12. A portable charging system for a portable mobile device, the charging system comprising:
a charging dock having a top surface, an opposing bottom surface, at least two sidewalls extending between said top and bottom surfaces, a charging cavity opened from the top surface having a bottom side, and at least two charging pins provided at the bottom side of the charging cavity; and
at least one battery bank having a top surface, an opposing bottom surface, and one or more sidewalls extending between said top and bottom surfaces, wherein the at least one battery bank has a charging cable originating at an integrated connection point next to, on, or in the opposing bottom surface, a groove along the one or more sidewalls from the connection point to the top surface for storing a cable portion of the charging cable, and a storage cavity in the top surface for storing a charging connector of the charging cable.

13. The portable charging system of claim 12, wherein the charging pins of the charging dock can plug into the charging contacts of the battery bank when the battery bank is secured in the charging cavity to supply power to the battery bank while also providing further stability to the battery bank that is in charging position.

14. The portable charging system of claim 13, wherein the storage cavity is designed to grip the charging connector.

15. The portable charging system of claim 13, wherein the angle of the storage cavity relative to the groove is sufficient to hold the charging connector in the storage cavity and the cable portion in the groove by way of tension applied along the length of the charging cable when the charging connector is placed into the storage cavity.

16. The portable charging system of claim 14, wherein the groove is designed to grip the cable portion of the charging cable.

17. The portable charging system of claim 14, wherein the opposing bottom surface has at least one of a standardized charging connection port, a pair of charging pins or contacts, and a wireless interface for receiving power to charge the battery bank.

18. The portable charging system of claim 14, wherein the battery bank further includes a connector cap to cover the charging connector when it is inserted into the storage cavity.

19. The portable charging system of claim 14, wherein the housing of the battery bank contains at least one rechargeable battery.

20. The portable charging system of claim 14, wherein the battery bank is permanently sealed to preclude the removal or replacement of the at least one rechargeable battery.
